(19) United States
(12) Patent Application Publication
(10) Pub. No.: US 2025/0092257 A1
(43) Pub. Date: Mar. 20, 2025

(54) RECYCLABLE VITRIMER POLYMER, LIGHTWEIGHT HEAT-DISSIPATING POLYMER COMPOSITE COMPRISING THE SAME, AND MANUFACTURING METHOD THEREOF

(71) Applicant: PUSAN NATIONAL UNIVERSITY INDUSTRY-UNIVERSITY COOPERATION FOUNDATION, Busan (KR)

(72) Inventors: Chae Bin KIM, Busan (KR); Dupyo JEON, Busan (KR); Yeomyung YOON, Busan (KR)

(73) Assignee: PUSAN NATIONAL UNIVERSITY INDUSTRY-UNIVERSITY COOPERATION FOUNDATION, Busan (KR)

(21) Appl. No.: 18/369,487

(22) Filed: Sep. 18, 2023

(51) Int. Cl. C08L 79/02; C08J 3/12; C08K 3/013

(52) U.S. Cl. CPC C08L 79/02; C08J 3/12; C08K 3/013; C08J 2379/02; C08K 2201/001; C08L 2312/00

(57) ABSTRACT

A recyclable vitrimer polymer composition includes: a first monomer containing at least one amine group at the terminal thereof; and a second monomer containing at least one acrylate group at the terminal thereof. The N—H group of the first monomer and the acrylate group of the second monomer react with each other in a ratio of 1:0.5 to 1.5.

### BACKGROUND

The present invention relates to an environmentally friendly and mechanically and chemically recyclable vitrimer polymer, a polymer composite containing the same, and a manufacturing method thereof, and more particularly to a novel vitrimer polymer capable of being reprocessed and chemically decomposed, a lightweight polymer composite with a thermal conductivity of 10 W/mK or above using the vitrimer polymer and a heat-dissipating filler, and a manufacturing method thereof.

With the advent of the “Fourth Industrial Revolution,” electronic components and microprocessors are becoming denser and smaller. As a result, heat density is rapidly increasing due to the rise in resistance caused by operation. If the heat generated under these circumstances is not efficiently dissipated to the outside, it can lead to device overheating, reduced reliability, shortened lifespan, and even device explosions. To prevent these issues, effective thermal dissipation within electronic devices is crucial. However, despite efforts to miniaturize electronic devices, the development of heat-dissipating materials with efficient thermal conductivity lags behind.

Until now, heat-dissipating materials have primarily utilized metals or ceramics with excellent thermal conductivity, but they have disadvantages such as being heavy, expensive, and not very malleable. Due to these drawbacks, they are not effective in terms of lightweighting and cost reduction. To address these issues, polymer composite materials that combine a high-thermal-conductivity ceramic filler with a polymer matrix that is both malleable and lightweight have gained attention. However, achieving high thermal conductivity in the polymer composite is challenging due to the inherently low thermal conductivity of the polymer. Additionally, a high loading of filler is typically required, leading to compromised properties and processability and failure in achieving lightweight goals. This is because the thermal conductivity of the composite material is determined by the heat transfer paths formed by the linking between the thermally conductive fillers within the polymer matrix. Therefore, there is an urgent need for a manufacturing method for high-performance heat dissipation polymer composite materials that can form a filler network even with a relatively low filler content.

Furthermore, as the production and usage of plastics commonly used in daily life, such as thermosetting polymer resins used in heat-dissipating polymer composite materials, continue to increase each year, the amount of waste plastics generated is also rapidly rising. Since plastics do not decompose easily, the waste plastic landfill can lead to environmental contamination in the future. In the case of incineration, large amounts of hazardous substances are released into the atmosphere, causing new environmental pollution. Further, the amount of waste plastics entering the coastal areas is consistently increasing. Thus, environmental issues that pose a threat to ecosystems through improper plastic disposal methods are consistently being highlighted.

The current methods of plastic recycling can be broadly categorized into three approaches: mechanical recycling, chemical recycling, and thermal recycling. Thermal recycling is incinerating polymers to obtain energy and applicable to all types of waste plastics. While relatively straightforward, this method is highly discouraged due to the emission of toxic gases, contributing to air pollution. As a result, there is a need for the development of polymer resins suitable for mechanical and chemical recycling, rather than relying on thermal recycling.

The mechanical recycling method is an environmentally friendly recycling process that involves the steps of sorting and washing waste plastics, followed by thermal processing to reuse the waste plastics as raw materials. This method is relatively simple and does not contribute to air pollution. Among the different types of plastics, thermosetting resins with excellent chemical resistance, mechanical strength and structural integrity are used for heat dissipation and various composite material resins. However, these thermosetting resins cannot be reprocessed through mechanical recycling as they do not melt by heat, posing limitation on the recyclability. Recently, a new polymer called “vitrimer” has gained attention, possessing the advantages of the thermosetting resins while being able to be thermally processed. These characteristics are achieved through dynamic interchain crosslinking bonds in the polymer, forming a network. For the reprocessing of the vitrimer, both organic and inorganic catalysts are typically employed to accelerate the interchain exchange reaction of dynamic crosslinking bonds. The use of these catalysts can lead to polymer degradation and corrosion of various components in the recycling process. Additionally, mechanical recycling only allows for the production of products of equivalent quality or lower quality compared to the original product. For instance, discarded PET bottles can be recycled into identical PET bottles or products of lesser value than PET bottles.

The recycling method for addressing these issues with plastics is chemical recycling. Chemical recycling involves breaking down waste plastics into monomers and small molecules, which are then used to synthesize a new product. This method is more complex than mechanical recycling but offers the potential for creating an added value from the waste plastics. However, the chemical recycling requires the use of toxic organic solvents to melt the plastics chemically, and it presents essential challenges such as high temperature, high pressure, and environmentally harmful processes involving complex conditions like acidity and alkalinity.

Therefore, there is a need for the development of high-performance heat dissipation polymer materials that are environmentally friendly, recyclable, and capable of forming a filler network with a relatively low filler content.

### SUMMARY

It is an object of the present invention to provide an environmentally friendly vitrimer polymer capable of being mechanically and chemically recycled, and a manufacturing method thereof.

It is another object of the present invention to provide a lightweight heat-dissipating polymer composite with a high thermal conductivity of 10 W/mK or above that contains the vitrimer polymer and a heat-dissipating filler, and a manufacturing method thereof.

To accomplish the above objects, the present invention provides a recyclable vitrimer polymer composition that comprises a first monomer containing at least one amine group at the terminal thereof; and a second monomer containing at least one acrylate group at the terminal thereof, wherein the N—H group of the first monomer and the acrylate group of the second monomer react with each other in a ratio of 1:0.5 to 1.5.

The first monomer may be represented by the following chemical formula 1.

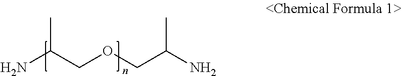

In the chemical formula 1, n is a rational number of 1 to 5.

The second monomer may be represented by the following chemical formula 2.

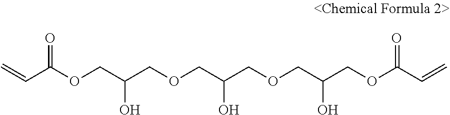 [SMILES: C=CC(=O)OCC(O)COCC(O)COCC(O)COC(=O)C=C]

The vitrimer polymer may be represented by the following chemical formula 3.

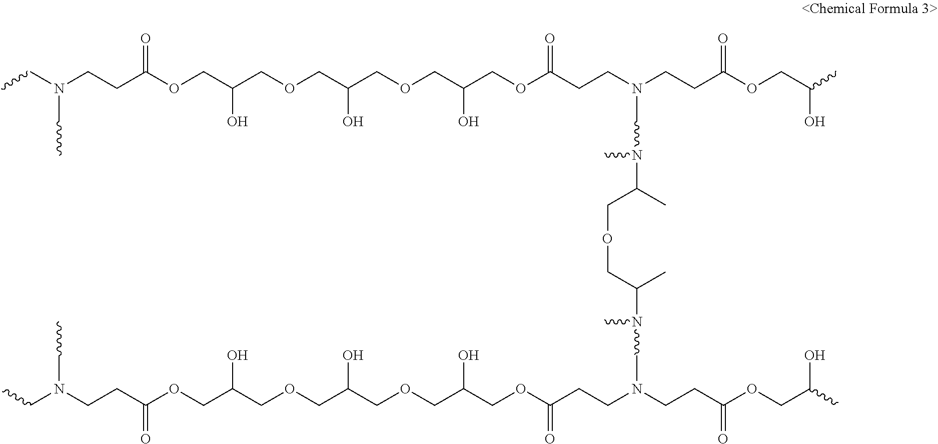

The present invention also provides a method for manufacturing a recyclable vitrimer polymer that comprises: mixing and heating a first monomer containing at least one amino group at the terminal thereof and a second monomer containing at least one acrylate group at the terminal thereof, wherein the first and second monomers are mixed so that the N—H group of the first monomer and the acrylate group of the second monomer react with each other in a ratio of 1:0.5 to 1.5.

The first monomer may be represented by the following chemical formula 1.

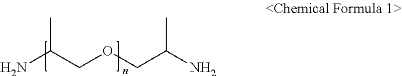

In the chemical formula 1, n is a rational number of 1 to 5.

The second monomer may be represented by the following chemical formula 2.

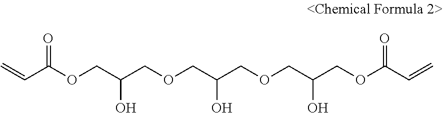 [SMILES: C=CC(=O)OCC(O)COCC(O)COCC(O)COC(=O)C=C]

The vitrimer polymer may be represented by the following chemical formula 3.

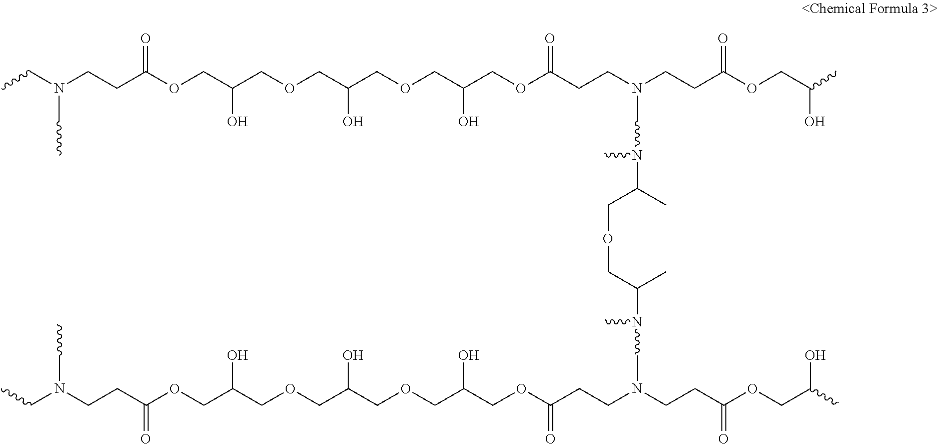

The step of mixing and heating the first and second monomers may be performed without a catalyst at 90 to 110° C. for 2 to 5 hours.

The vitrimer polymer may be synthesized through an Aza-Michael addition reaction.

The present invention also provides a recyclable vitrimer polymer produced according to the method of manufacturing a recyclable vitrimer polymer.

The vitrimer polymer may have a network topology rearranged through a transesterification reaction.

The vitrimer polymer may be mechanically recyclable without a catalyst.

The vitrimer polymer may be chemically recyclable using a non-toxic solvent.

The present invention also provides a lightweight thermally conductive polymer composite comprising: the aforementioned recyclable vitrimer polymer; and a heat-dissipating filler, wherein the heat-dissipating filler is separated from domains of the vitrimer polymer and positioned between the domains.

The heat-dissipating filler may be at least one selected from the group consisting of hexagonal boron nitride (h-BN), graphene, silicene, molybdenum disulfide (MoS₂), phosphorene, and borophene.

The polymer composite may have a thermal conductivity of 10 W/mK or above.

The polymer composite may be recyclable.

The present invention also provides a method for manufacturing a lightweight thermally conductive polymer composite, comprising: grinding the recyclable vitrimer polymer into a powder; mixing the ground vitrimer powder and a heat-dissipating filler to coat the vitrimer powder with the heat-dissipating filler; and thermally molding the vitrimer powder coated with the heat-dissipating filler to form a composite material.

The heat-dissipating filler may be contained in an amount of 20 to 60 parts by volume with respect to 100 parts by volume of the mixture of the vitrimer powder and the heat-dissipating filler.

Using the characteristics of the vitrimer of the present invention, mixing the vitrimer with a heat-dissipating filler, even at a low filler content, can facilitate formation of a filler-to-filler network and effectively establish heat transfer pathways, making it possible to produce a lightweight high-performance heat-dissipating polymer composite material with a high thermal conductivity.

The vitrimer can be mechanically and chemically recycled through an environmentally friendly process. Not only can valuable fillers be recovered from the polymer composite material, but also vitrimer recycling is possible, allowing for the production of a high-performance heat-dissipating polymer composite that is completely recyclable, light-weighted and environmentally friendly.

The recycled polymer composite can be resynthesized into various general-purpose polymers, such as urethane, epoxy or nylon, forming a basis for diverse applications in related industries.

### BRIEF DESCRIPTION OF THE DRAWINGS

FIG. 1 presents ATR-FTIR (Attenuated Total Reflection-Fourier Transform Infrared) spectra before and after heating in the synthesis process of a poly(β-amino ester) (PBAE) vitrimer according to an embodiment of the present invention.

FIG. 2 presents the isothermal DSC (Differential Scanning calorimetry) curve (100° C.) of a monomer mixture for PBAE vitrimer synthesis.

FIG. 3 is a graph showing the gel content (GC) as a function of the curing time for PBAE vitrimer synthesis.

FIG. 4 is a graph showing the results of a DMA (Dynamic Mechanical Analysis) on the cured PBAE vitrimer.

FIG. 5 illustrates the transesterification reaction of the PBAE vitrimer.

FIG. 6 is a graph showing the results of a TGA (Thermo Gravimetric Analysis) on the PBAE vitrimer.

FIG. 7 is a graph showing the results of a stress relaxation test on the PBAE vitrimer at various temperatures.

FIG. 8 is a graph showing the results of FIG. 7 according to the Arrhenius law.

FIG. 9 is a graph showing the deformation ratio of the PBAE vitrimer samples according to the temperature through a non-isothermal creep experiment.

FIG. 10 presents the results of mechanical recycling using the melt-processability of the PBAE vitrimer.

FIG. 11 presents graphs showing the results of UTM (Universal Testing Machine) (left) and ATR-FTIR (right) analysis on the mechanically recycled PBAE vitrimer according to FIG. 10.

FIG. 12 shows the change in the state of the PBAE vitrimer in various solvents at 90° C. for chemical recycling.

FIG. 13 depicts the mechanism of thermal hydrolysis at temperatures of Tᵥ or above.

FIG. 14 presents ATR-FTIR spectra of the PBAE vitrimer before and after thermal hydrolysis.

FIG. 15 presents the thermal hydrolysis curves of the PBAE vitrimer according to the temperature.

FIG. 16 illustrates the process of manufacturing a composite using the PBAE vitrimer and fillers.

FIG. 17 is a graph showing a comparison of thermal conductivity between the two composites manufactured by the process of FIG. 16.

FIG. 18 depicts the chemical recycling process of the above-manufactured PBAE vitrimer composite.

FIG. 19 presents a comparison of the quality between the collected filler and the stock filler in the chemical recycling process of FIG. 18 using TGA (left) and Raman spectroscopy (right).

FIG. 20 depicts the mechanical recycling (a) and chemical recycling (b) of the vitrimer composite.

### DETAILED DESCRIPTION

Hereinafter, a detailed description of the present invention will be provided.

The present inventor has developed a novel vitrimer that can be reprocessed without the use of an external catalyst and decomposed using an environmentally friendly solvent, water. By utilizing the characteristics of the vitrimer, mixing the vitrimer with a heat-dissipating filler forms a filler-to-filler network easily even at a relatively low filler content. This allows for the effective formation of heat transfer pathways, enabling the production of a lightweight high-performance heat dissipation polymer composite material, thereby completing the present invention.

The present invention provides a novel vitrimer polymer composition that is capable of being recycled or reprocessed.

In this specification, the term “vitrimer” refers to a polymer composed of a molecular-shared network that can change topologies through a thermally activated bond exchange reaction, which means that the polymer possesses both the chemical stability of a thermosetting polymer and the processability of a thermoplastic polymer.

The recyclable vitrimer polymer composition according to the present invention may include a first monomer containing at least one amine group at the terminal thereof, and a second monomer containing at least one acrylate group at the terminal thereof. The N—H group of the first monomer and the acrylate group of the second monomer may react with each other in a ratio of 1:0.5 to 1.5, preferably 1:1.

The first monomer may be a polyether amine compound. Preferably, it may be represented by the following chemical formula 1, but is not limited thereto.

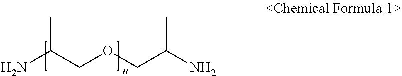

In the chemical formula 1, n may be a rational number of 1 to 5, preferably 2 to 3, and more preferably 2.3, but is not limited thereto.

Preferably, the second monomer may be represented by the following chemical formula 2, but is not limited thereto.

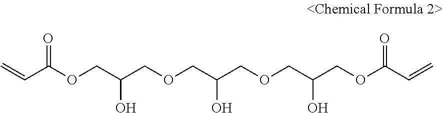 [SMILES: C=CC(=O)OCC(O)COCC(O)COCC(O)COC(=O)C=C]

Preferably, the vitrimer polymer may be represented by the following chemical formula 3, but is not limited thereto.

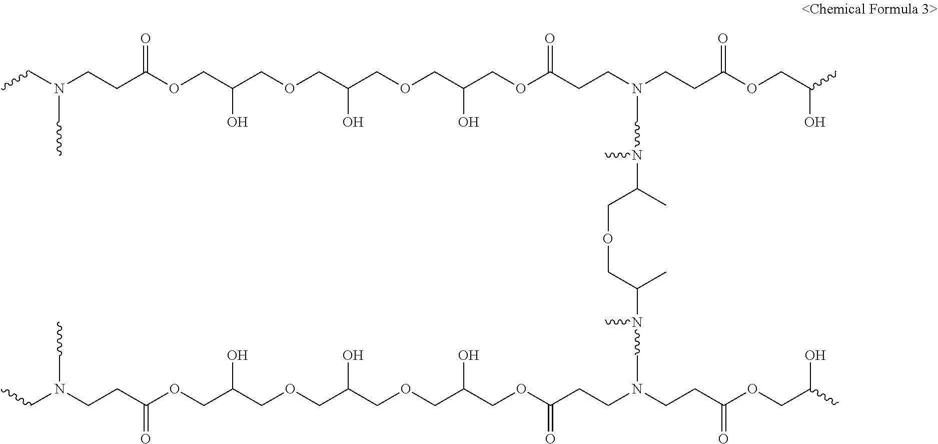

The present invention also provides a method for manufacturing a novel vitrimer polymer that is capable of being recycled or reprocessed.

The method for manufacturing a recyclable vitrimer polymer according to the present invention may include mixing and heating a first monomer containing at least one amine group at the terminal thereof and a second monomer containing at least one acrylate group, preferably at least two acrylate groups, at the terminal thereof.

The first monomer may be a polyether amine compound. Preferably, it may be represented by the following chemical formula 1, but is not limited thereto. The second monomer may be represented by the following chemical formula 2, but is not limited thereto.

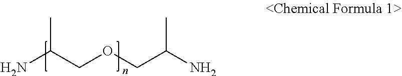

In the chemical formula 1, n may be a rational number of 1 to 5, preferably 2 to 3, and more preferably 2.3, but is not limited thereto.

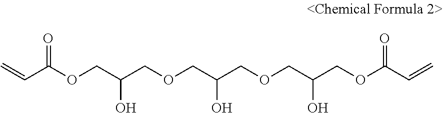 [SMILES: C=CC(=O)OCC(O)COCC(O)COCC(O)COC(=O)C=C]

The step of mixing and heating the first and second monomers may be performed to mix the first and second monomers so that the N—H group of the first monomer and the acrylate group of the second monomer react with each other in a ratio of 1:0.5 to 1.5, preferably 1:1.

The vitrimer polymer may be synthesized under mild conditions without a catalyst using an Aza-Michael addition reaction. Preferably, the step of mixing and heating the first and second monomers may be conducted without a catalyst at 90 to 110° C., more preferably at 100° C., for 2 to 5 hours, more preferably for 4 hours, but is not limited thereto.

According to the manufacturing method, the vitrimer polymer may be produced into a form of the following chemical formula 3, preferably a vitrimer polymer having a poly(β-amino ester) (PBAE) bond.

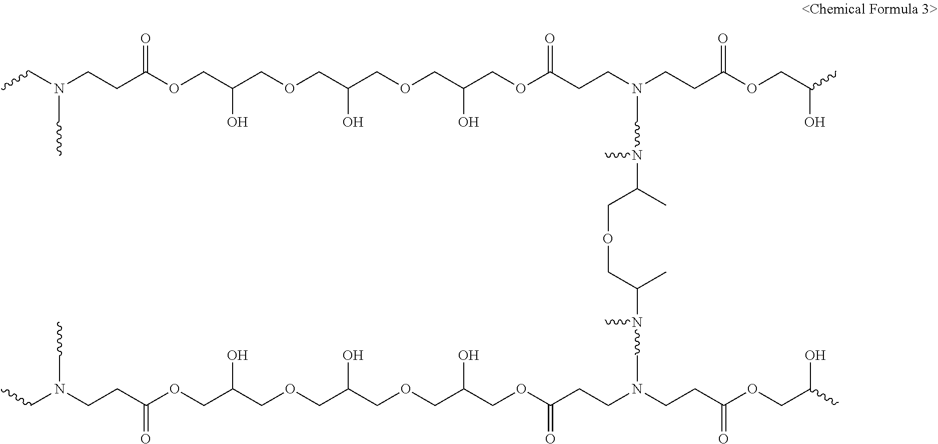

The present invention also provides a recyclable vitrimer polymer produced according to the method for manufacturing a recyclable vitrimer polymer.

The vitrimer polymer can be synthesized by an Aza-Michael addition reaction, enabling the interchain exchange reaction of dynamic crosslinking bonds, allowing for mechanical recycling without the need for an external catalyst.

Furthermore, the vitrimer polymer can have the rearrangement of network topology through a transesterification reaction, allowing for chemical recycling simply by heating using a non-toxic, environmentally friendly solvent.

Besides, the vitrimer polymer exhibits high chemical resistance to organic solvents and excellent thermal stability.

The present invention also provides a lightweight polymer composite with thermal conductivity and heat-dissipating properties that comprises the recyclable vitrimer polymer; and a heat-dissipating filler, wherein the heat-dissipating filler is separated from the domains of the vitrimer polymer and positioned between the domains.

The heat-dissipating filler may be selected from the plate-like fillers having thermal conductivity and anisotropy. More specifically, the plate-like filler may include hexagonal boron nitride (h-BN), graphene, silicene, molybdenum disulfide (MoS₂), phosphorene, or borophene, and preferably hexagonal boron nitride (h-BN), but is not limited thereto.

The heat-dissipating filler may be not penetrated into the vitrimer but situated in a segregated form outside the polymer domains, between the polymer domains in the vitrimer, due to its malleability (not flowing like a fluid but being able to be processed into a new shape) based on the dynamic exchange reaction, but it is not limited thereto.

The heat-dissipating filler may be contained in an amount of 20 to 60 parts by volume with respect to 100 parts by volume of the mixture of the vitrimer polymer and the heat-dissipating filler. Even with a low content of the heat-dissipating filler ranging from 20 to 40 parts by volume, the lightweight thermally conductive polymer composite can exhibit excellent thermal conductivity of 5 W/mK or above, and preferably 10 W/mK or above.

The lightweight thermally conductive polymer composite can also be recycled. Preferably, through chemical recycling, both the vitrimer polymer and the heat-dissipating filler of the lightweight thermally conductive polymer composite can be fully recycled.

The present invention also provides a method for manufacturing a lightweight thermally conductive polymer composite that comprises: grinding the recyclable vitrimer polymer into a powder; mixing the ground vitrimer powder and a heat-dissipating filler to coat the vitrimer powder with the heat-dissipating filler; and thermally molding the vitrimer powder coated with the heat-dissipating filler to form a composite material.

The heat-dissipating filler may be contained in an amount of 20 to 60 parts by volume with respect to 100 parts by volume of the mixture of the vitrimer powder and the heat-dissipating filler, allowing for the production of a lightweight thermally conductive polymer composite having excellent thermal conductivity even with such a low content of the heat-dissipating filler.

Hereinafter, for a better understanding of the invention, embodiments will be described in detail with reference to examples. However, it should be understood that these embodiments are merely illustrative of the invention and are not meant to limit the scope of the invention. These embodiments of the invention are provided to more fully describe the invention to those skilled in the art.

### <Example 1> Synthesis of Poly(β-Amino Ester) (PBAE) or PBAE Vitrimer

### 1. Synthesis of PBAE Vitrimer Using Aza-Michael Addition Reaction

Michael addition reactions have the advantage of providing high yields even under mild click reaction conditions. Among them, the thiol-Michael reaction often requires basic catalysts to deprotonate thiols. On the other hand, the Aza-Michael reaction does not need the use of an additional catalyst due to the amine having nucleophilic properties and acting as a basic catalyst. Therefore, as given in the following reaction scheme 1, poly(propylene glycol) bis(2-aminopropyl ether) (PEA) (Mn ˜230) and triglycerol diacrylate (TGDA) were mixed to have the ratio of the N—H single bond of the amine to the acrylate group being 1:1. The mixture was then heated at 100° C. for 4 hours without a catalyst to undergo curing.

The following reaction scheme 1 depicts the synthesis process of the poly(beta-amino ester) (PBAE) vitrimer.

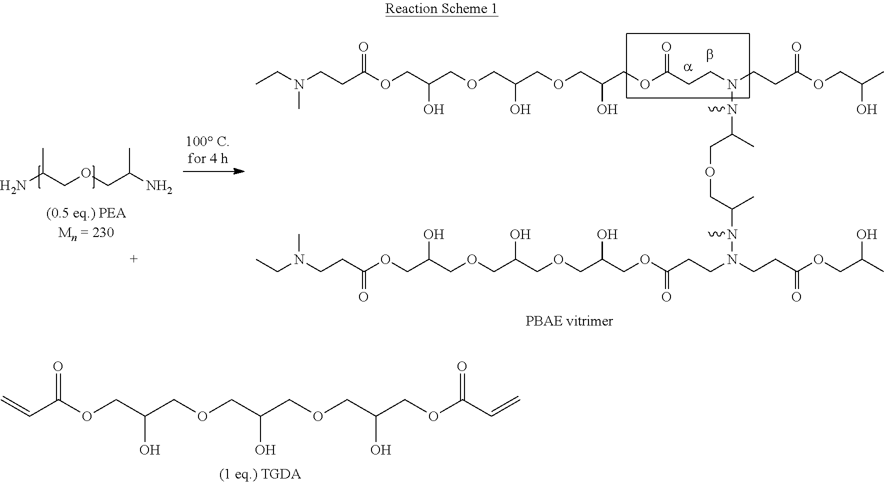

### <Experimental Example 1> Verification of PBAE Vitrimer Synthesis

The Aza-Michael reaction was verified through a comparison of the attenuated total reflection-Fourier transform infrared (ATR-FTIR) spectra before and after heating.

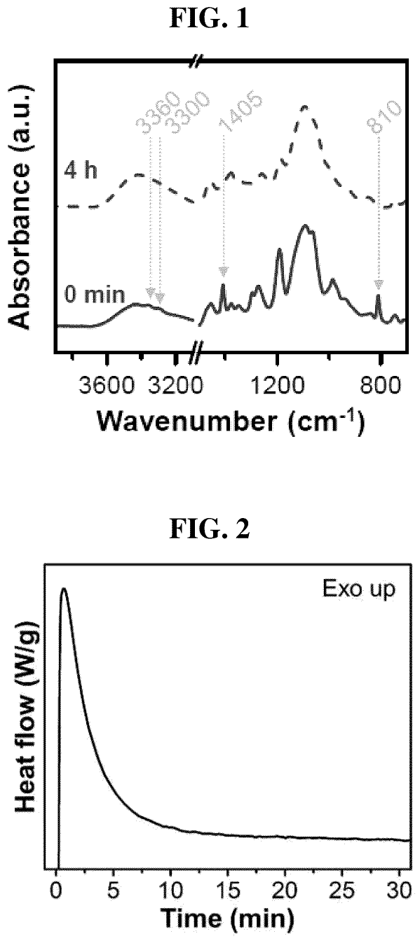

As shown in FIG. 1, after heating, a decrease in intensity was observed in the peaks of the amines at 3350 cm⁻¹ and 3300 cm⁻¹, as well as the acrylate peaks at 1405 cm⁻¹ and 810 cm⁻¹.

### <Experimental Example 2> Determination of Optimal Curing Conditions

The optimal curing conditions were determined through the differential scanning calorimetry (DSC) and gel content (GC).

Referring to FIG. 2, it was observed that an exothermic peak rapidly emerged from the onset on the 100° C. isothermal DSC curve of the monomer mixture. This indicates the occurrence of an Aza-Michael reaction between the two monomers at 100° C.

Furthermore, a gel content (GC) experiment was conducted using tetrahydrofuran (THF) as an optimal solvent for the two monomers in order to determine the bulk curing time at 100° C.

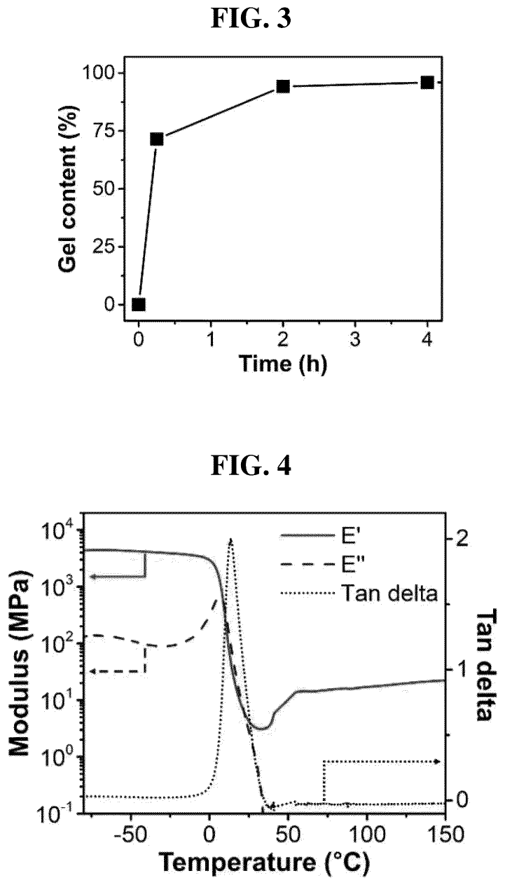

Referring to FIG. 3, a high GC of 95% was achieved in a reaction time of 2 hours. This indicated a high yield of the reaction between the two monomers, implying the formation of a cross-linked network, as evidenced by the fact that the reaction product did not dissolve in the organic solvent THF. It was accordingly determined that the optimal curing time for thoroughly complete curing was 4 hours.

According to a dynamic mechanical analysis (DMA) of the samples cured under the aforementioned conditions, a rubbery plateau of the storage modulus was observed as shown in FIG. 4.

In other words, the PBAE vitrimer was confirmed to form a cross-linked network structure through an Aza-Michael reaction and hence exhibit thermomechanical properties similar to those of thermosetting materials.

### <Experimental Example 3> Characteristics According to Bond Exchange Reaction (BER)

It was investigated whether the network topology can be rearranged through a dynamic exchange reaction in the PBAE vitrimer network synthesized according to an embodiment of the present invention and a conventional thermosetting network.

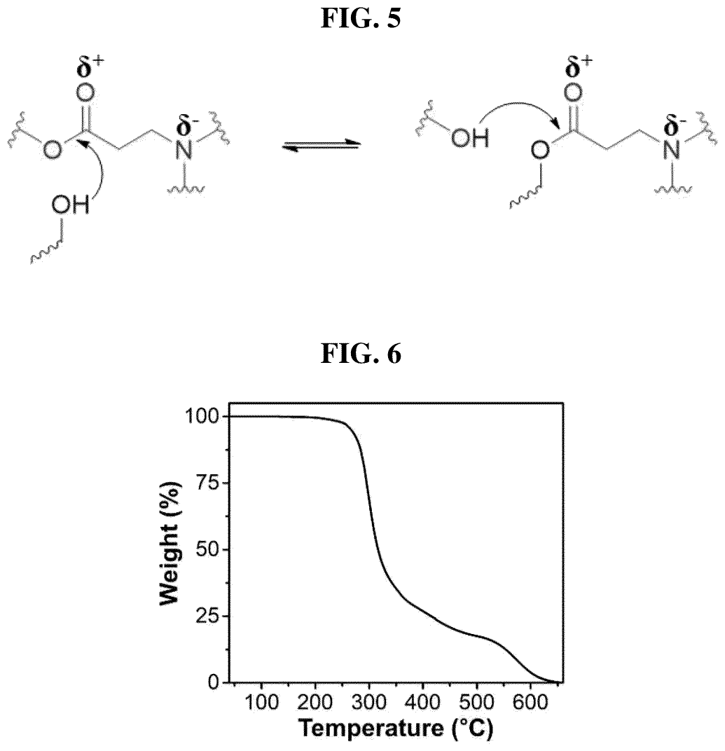

As the PBAE vitrimer has ester groups and hydroxyl groups for transesterification reaction and the nucleophilic amine of β-amino ester induces the ester groups to be more electrophilic, it is possible to accelerate the transesterification without an additional catalyst, as shown in FIG. 5. Accordingly, the PBAE vitrimer can have the rearrangement of network topology through a transesterification reaction.

In addition, according to a thermo gravimetric analysis (TGA) to measure the thermal stability of the PBAE vitrimer, it was revealed as shown in FIG. 6 that the PBAE vitrimer had a T_{d5}% of 266° C., indicating the appropriate temperature for transesterification reaction being 266° C. Consequently, experiments related to the exchange reactions were conducted at a temperature of 266° C. or below.

### <Experimental Example 4> Determination of Stress Relaxation Properties and Topology Freezing Transition Temperature (Tᵥ)

A stress relaxation testing was performed to confirm the exchange reaction of the network.

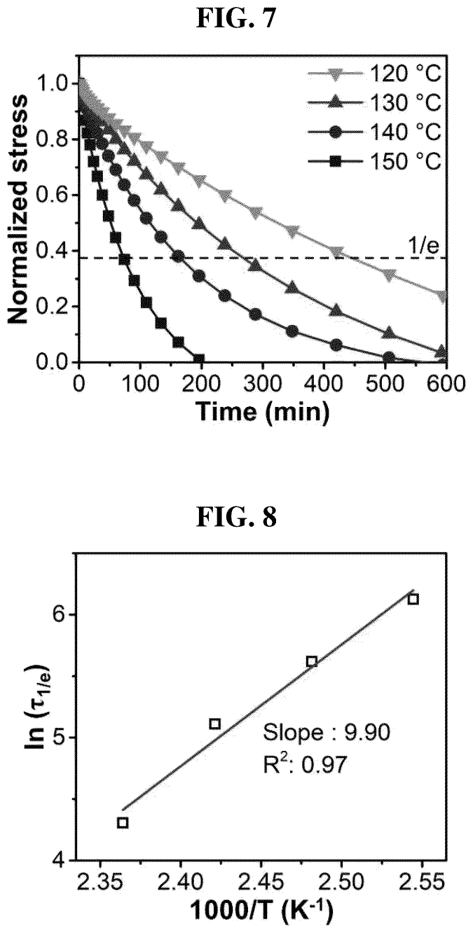

As shown in FIG. 7, when the test was conducted at intervals of 10° C. from 120° C. to 150° C., it was confirmed that the PBAE vitrimer had a complete stress relaxation, and that the stress was reduced more rapidly at higher temperatures.

As the relaxation of the vitrimer is governed by the dynamic exchange reaction, the relation between temperature and relaxation rate can be explained by the chemical reaction-based Arrhenius equation. According to the Arrhenius equation, the rate of the chemical reaction (the rate of relaxation by the dynamic exchange reaction in the case of the vitrimer) is proportional to the temperature.

Setting the relaxation time as the time for normalized stress to reach 1/e and plotting In(τ) against 1000/T, the relaxation time with respect to temperature could be linearly fitted according to the Arrhenius law, as shown in FIG. 8. Through this, the activation energy of the transesterification reaction in the PBAE vitrimer was calculated to be 82 KJ/mol.

According to the research by the Du Prez Group, the vitrimer containing β-amino esters can undergo a dynamic exchange reaction through a dissociative-type retro Aza-Michael reaction.

However, the PBAE vitrimer according to an embodiment of the present invention did not undergo the related reaction in the temperature range from room temperature to 150° C. For instance, Arrhenius fitting did not show any dual temperature behavior resulting from a combination of transesterification reaction and retro Aza-Michael reaction; instead, only one relaxation behavior was observed. Additionally, in the DMA results, a decrease in storage modulus due to the dissociative exchange reaction was not observed up to 150° C. Thus, it can be inferred that the transesterification reaction dominates as a dynamic exchange reaction in the temperature range from room temperature to 150° C., and the property changes due to the retro Aza-Michael reaction are minimal.

The Tᵥ (transition temperature) was determined through an elevated temperature creep experiment.

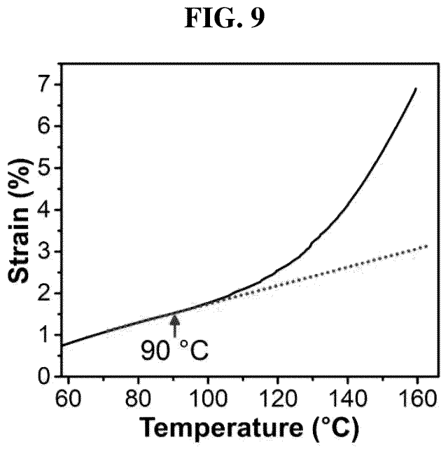

The deformation rate of samples according to temperature was measured, and the thermal history was analyzed. As shown in FIG. 9, the samples had a deformation rate increase linearly due to thermal expansion in the temperature range of 60 to 90° C., similar to typical thermosetting polymers; whereas the slope of the deformation rate gradually increased at temperatures above 90° C. This feature is characteristic to the vitrimer, where malleability is acquired through a dynamic exchange reaction. The dynamic exchange reaction reduces the stress applied to the samples, and the deformation rate is gradually increased under a constant stress. It is therefore confirmed that the boundary temperature of 90° C. is the Ty of the PBAE vitrimer.

### <Experimental Example 5> Recycling of PBAE Vitrimer

### 1. Mechanical Recycling

A fully cured PBAE sample was cut into small pieces and used as materials for hot press molding. These pieces were pressed while heated at 120° C. and 10 MPa for 1 hour. This process was repeated up to 3 times using the same sample, and the reprocessed samples were analyzed using a universal testing machine (UTM) and ATR-FTIR each time.

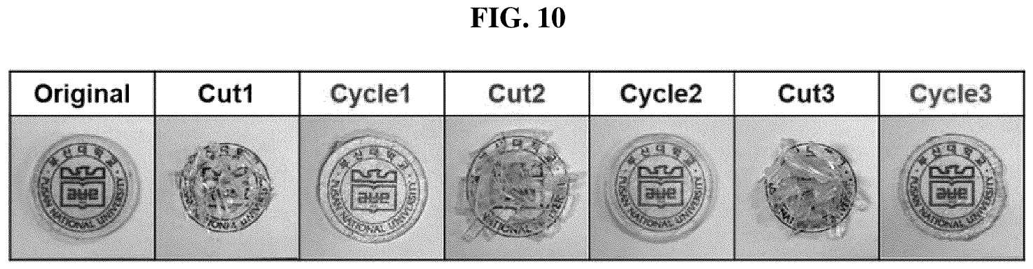

As shown in FIG. 10, the reprocessed samples were formed into a disc, transparent as the original, indicating that the transesterification reaction made the PBAE vitrimer malleable and thereby successfully recyclable. It was thus demonstrated that the PBAE vitrimer could be mechanically recycled multiple times without the need for any additional catalyst at temperatures above Tᵥ.

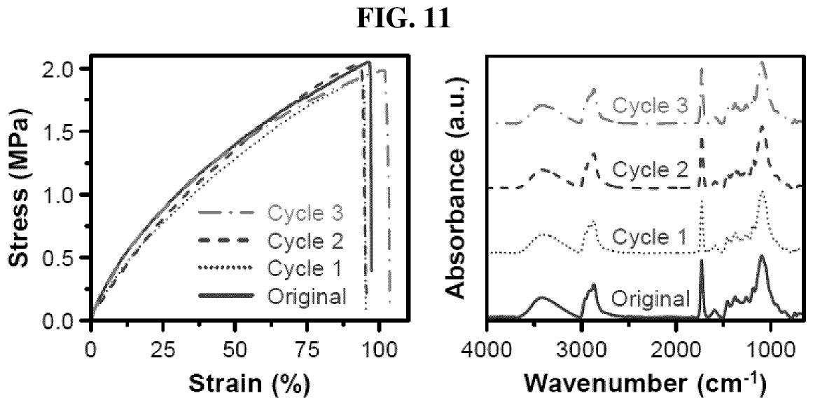

Referring to FIG. 11, recycling was effectively achieved due to the transesterification reaction of β-amine accelerated even without a catalyst, and there were no significant differences in mechanical properties and chemical structure compared to the original. The reprocessed samples all maintained the mechanical properties of the original (left).

Additionally, the ATR-FTIR spectra before and after continuous reprocessing showed close alignment, and no signals indicating chemical or thermal oxidation or decomposition were detected (right).

### 2. Chemical Recycling

Chemical recycling of the PBAE vitrimer according to one embodiment of the present invention was conducted using an environmentally friendly solvent, water.

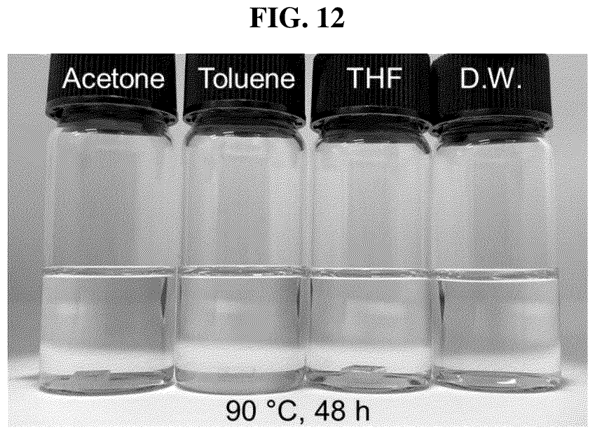

Firstly, the PBAE vitrimer was immersed in THF (tetrahydrofuran), toluene, acetone, and water at 90° C. for 7 days. As shown in FIG. 12, the PBAE vitrimer remained insoluble in THE, toluene and acetone at 90° C. for 48 hours due to its highly crosslinked network structure, imparting excellent chemical resistance, while disintegration of the network and depolymerization occurred in water at 90° C., resulting in no sample recovery.

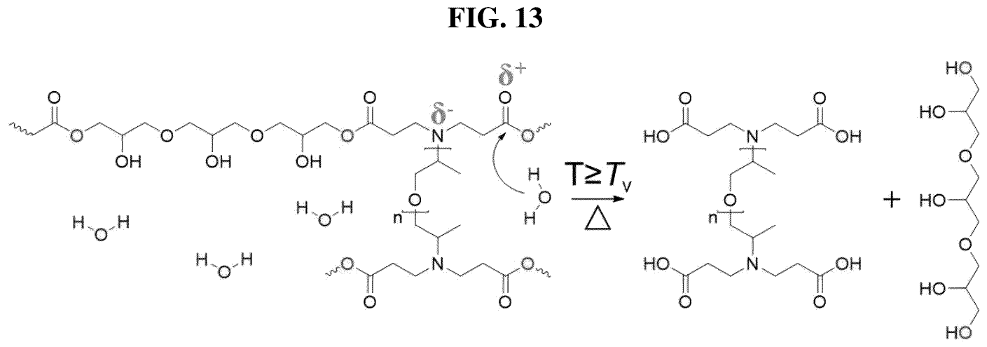

This phenomenon is related to the thermal hydrolysis of the PBAE vitrimer (FIG. 13). Thermal hydrolysis is a substitution reaction in which the hydroxyl group attacks the carbonyl group of the ester, similar to the transesterification reaction. As explained in the dynamic exchange reaction of the PBAE vitrimer, the β-amine facilitates the activation of the ester in such a substitution reaction. Consequently, even without an external catalyst, the PBAE vitrimer can react with the hydroxyl group of water at temperatures above Tᵥ to undergo decrosslinking and thermal hydrolysis.

The sample decomposed in the solvent was collected, dried, and analyzed through ATR-FTIR, which revealed that the sample was depolymerized by the thermal hydrolysis.

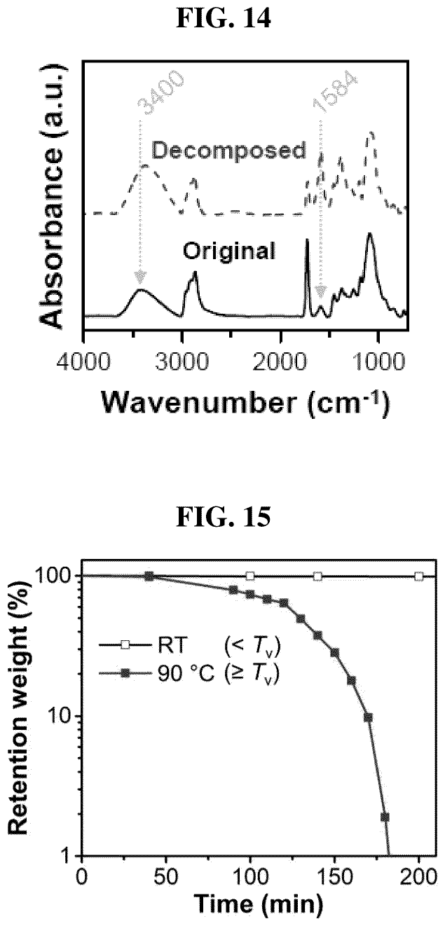

As depicted in FIG. 14, after decomposition, there were an increase in the broad peak intensity at 3400 cm⁻¹ corresponding to —OH and —COOH, a decrease in the peak intensity at 1730 cm⁻¹ for an ester, and an increase in the peak intensity at 1585 cm⁻¹ for a strong carboxylic acid, indicating the hydrolysis of the ester group into a carboxylic acid group and an alcohol group.

Furthermore, the temperature-dependent thermal hydrolysis was investigated.

The PBAE vitrimer was immersed in water at temperatures above Tᵥ (90° C.), where an exchange reaction occurs, and at room temperature, where no exchange reaction takes place, for 200 minutes. The change in the weight of the sample over time was observed.

As shown in FIG. 15, at room temperature, no significant weight change occurred due to the absence of thermal hydrolysis. Conversely, at 90° C., an exchange reaction and subsequent thermal hydrolysis led to a gradual decrease in the weight of the sample. Therefore, this thermal hydrolysis is believed to be associated with the dynamic exchange reaction and the transition temperature, Tᵥ, of the vitrimer.

Accordingly, it can be concluded that the PBAE vitrimer is chemically recyclable under mild and catalyst-free conditions using an environmentally friendly solvent, water.

### <Example 2> Manufacture and Recycling Evaluation of Vitrimer Composite Material

With the recent trends towards environmental friendliness, lightweight design, and energy integration of electronic devices, the development of thermally conductive polymer composite materials that are both recyclable and excellent in thermal conductivity has become crucial. Typically, the thermally conductive composite is manufactured by blending a filler, which is heavy with a high thermal conductivity, and a thermosetting polymer matrix, which is light and heat-resistant with a low thermal conductivity. However, the thermosetting polymer poses challenges in recycling, and there exists a trade-off between the weight and thermal conductivity of the composite material. Accordingly, a recyclable composite material was produced using the PBAE vitrimer prepared according to the Example 1. This composite material features a segregated filler structure containing a small amount of filler, which contributes to lightweightness and high thermal conductivity.

### 1. Manufacturing Method

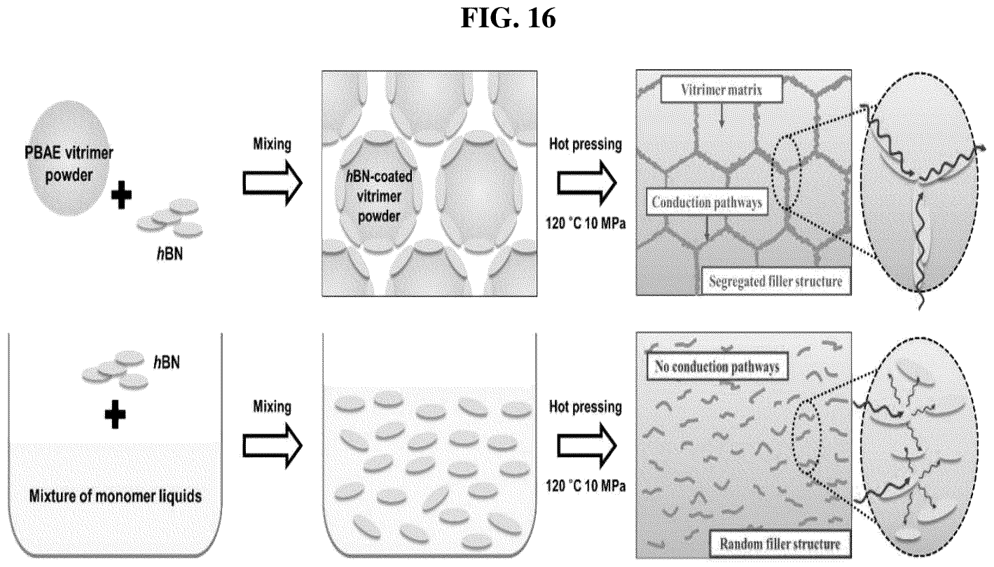

As shown in the upper part of FIG. 16, the cured PBAE vitrimer was finely ground into powder form and mixed with a hexagonal boron nitride (h-BN) filler in a hexagonal powder form. The vitrimer powder coated with the h-BN filler was placed in a mold and formed into a composite material through a hot-pressing process (powder mixing). The malleability of the vitrimer attributed by the dynamic exchange reaction resulted in a segregated filler structure, where the filler was not able to infiltrate the vitrimer domains but was selectively positioned between the domains.

As a control, a composite material with a random filler structure was prepared (shown in the lower part of FIG. 16). In the same manner of the conventional manufacturing method for composite material, a filler and a vitrimer monomer were mixed in a liquid form for uniform dispersion and then cured into a composite material (liquid mixing).

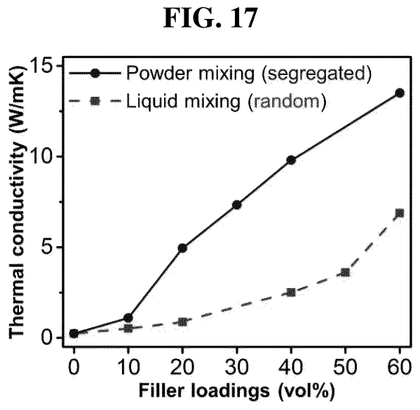

A comparison of thermal conductivity was made between the composite material with a segregated filler structure and the composite material with a random filler structure. As shown in FIG. 17, the samples with a segregated filler structure made by powder mixing exhibited significantly higher thermal conductivity, reaching up to 13.5 W/mK. At a thermal conductivity of approximately 7 W/mK, powder mixing resulted in a similar thermal conductivity with a lower filler content of 30 vol % and a significant decrease in density by 0.26 g/cm³ Thus, this manufacturing method using the powder mixing and the malleability of the vitrimer made it possible to produce a lightweight composite material with high thermal conductivity.

### 2. Recyclability

There was no difference in the thermal conductivity when the PBAE vitrimer composite material was slightly broken down for mechanical recycling. But, the thermal conductivity was reduced when the PBAE vitrimer composite material was fully ground into powder for mechanical recycling. This can be attributed to the fragmentation of the filler in the composite material.

Therefore, the PBAE vitrimer composite material was completely recycled through a chemical recycling process.

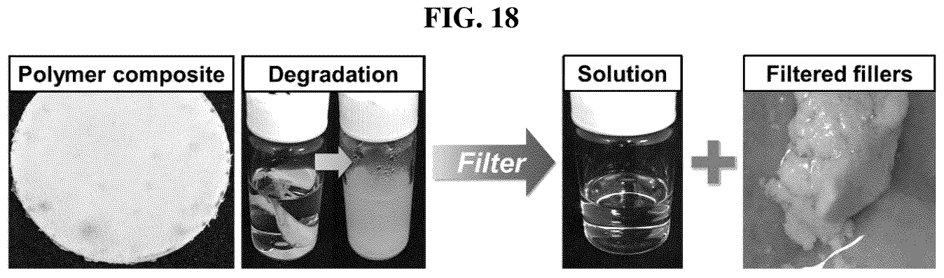

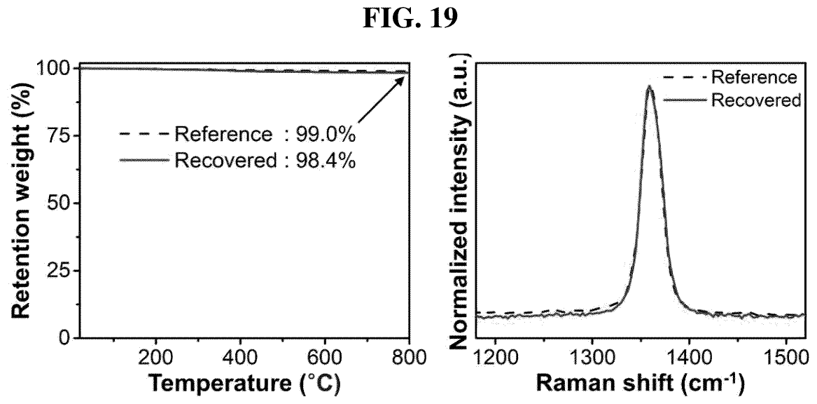

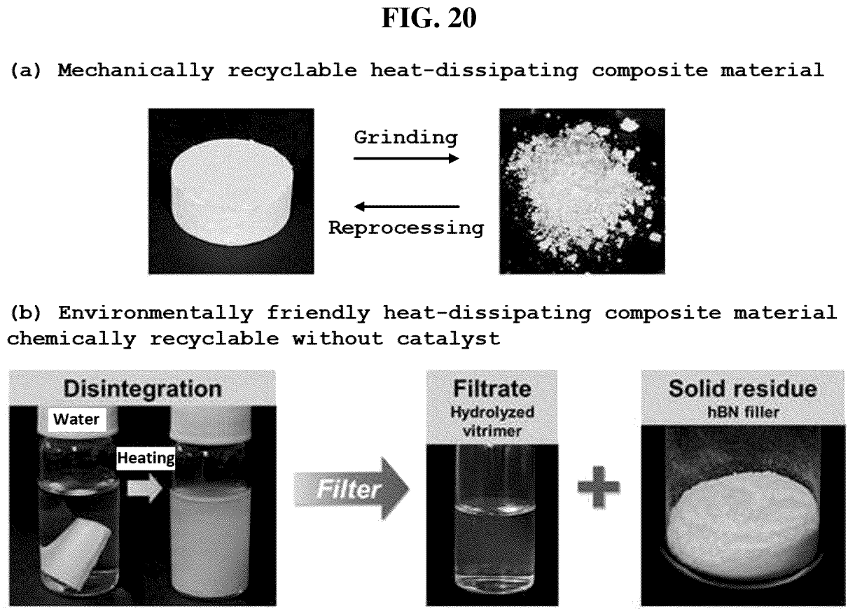

As shown in FIG. 18, the PBAE vitrimer was subjected to thermal hydrolysis to selectively degrade the matrix alone. Referring to FIG. 19, the collected filler exhibits a similar quality to the stock filler. This means that the collected filler can be reused like the stock filler. As the degraded matrix is also recyclable, the composite material using the PBAE vitrimer is considered as a composite material system with complete recyclability.

Although the specific aspects of the present invention have been described in detail, it is understood that the present invention should not be limited to these exemplary embodiments. Therefore, the scope of the present invention is not limited to the disclosed embodiment, and it should be defined by the scope of the following claims and equivalents thereof. The scope of the present invention is defined by the appended claims and should be construed as including all changes or modifications derived from the meaning and scope of the claims and their equivalents.

What is claimed is:

1. A recyclable vitrimer polymer composition comprising:
a first monomer containing at least one amine group at the terminal thereof; and
a second monomer containing at least one acrylate group at the terminal thereof,
wherein the N—H group of the first monomer and the acrylate group of the second monomer react with each other in a ratio of 1:0.5 to 1.5.

2. The recyclable vitrimer polymer composition according to claim 1, wherein the first monomer is represented by the following chemical formula 1: 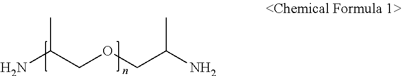
wherein n is a rational number of 1 to 5.

3. The recyclable vitrimer polymer composition according to claim 1, wherein the second monomer is represented by the following chemical formula 2:

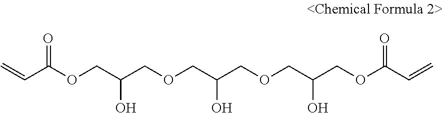 [SMILES: C=CC(=O)OCC(O)COCC(O)COCC(O)COC(=O)C=C]

4. The recyclable vitrimer polymer composition according to claim 1, wherein the vitrimer polymer is represented by the following chemical formula 3:

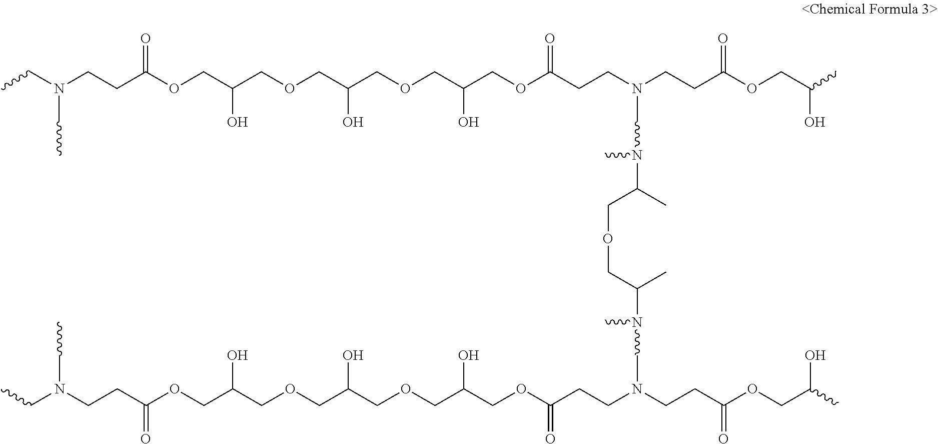

5. A method for manufacturing a recyclable vitrimer polymer composition, comprising:
mixing and heating a first monomer containing at least one amine group at the terminal thereof and a second monomer containing at least one acrylate group at the terminal thereof,
wherein the first and second monomers are mixed so that the N—H group of the first monomer and the acrylate group of the second monomer react with each other in a ratio of 1:0.5 to 1.5.

6. The method according to claim 5, wherein the first monomer is represented by the following chemical formula 1: 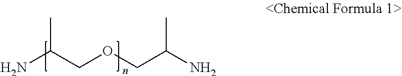
wherein n is a rational number of 1 to 5.

7. The method according to claim 5, wherein the second monomer is represented by the following chemical formula 2:

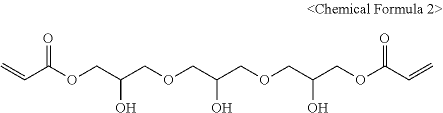 [SMILES: C=CC(=O)OCC(O)COCC(O)COCC(O)COC(=O)C=C]

8. The method according to claim 5, wherein the vitrimer polymer is represented by the following chemical formula 3:

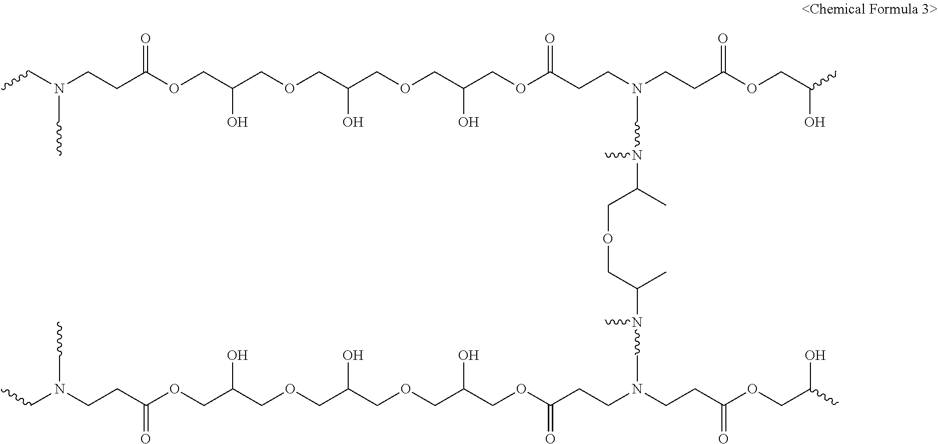

9. The method according to claim 5, wherein the step of mixing and heating the first and second monomers is performed without a catalyst at 90 to 110° C. for 2 to 5 hours.

10. The method according to claim 5, wherein the vitrimer polymer is synthesized through an Aza-Michael addition reaction.

11. A recyclable vitrimer polymer manufactured according to claim 5.

12. The recyclable vitrimer polymer according to claim 11, wherein the vitrimer polymer has a network topology rearranged through a transesterification reaction.

13. The recyclable vitrimer polymer according to claim 11, wherein the vitrimer polymer is capable of being mechanically recycled without a catalyst.

14. The recyclable vitrimer polymer according to claim 11, wherein the vitrimer polymer is capable of being chemically recycled using a non-toxic solvent.

15. A lightweight thermally conductive polymer composite comprising the recyclable vitrimer polymer according to claim 11; and a heat-dissipating filler,
wherein the heat-dissipating filler is separated from domains of the vitrimer polymer and positioned between the domains.

16. The lightweight thermally conductive polymer composite according to claim 15,
wherein the heat-dissipating filler is at least one selected from the group consisting of hexagonal boron nitride (h-BN), graphene, silicene, molybdenum disulfide (MoS₂), phosphorene, and borophene.

17. The lightweight thermally conductive polymer composite according to claim 15, wherein the polymer composite has a thermal conductivity of 10 W/mK or higher.

18. The lightweight thermally conductive polymer composite according to claim 15, wherein the polymer composite is recyclable.

19. A method for manufacturing a lightweight thermally conductive polymer composite, comprising:
grinding the vitrimer polymer according to claim 11 into a powder;
mixing the ground vitrimer powder and a heat-dissipating filler to coat the ground vitrimer powder with the heat-dissipating filler; and
thermally molding the vitrimer powder coated with the heat-dissipating filler to form a composite.

20. The method according to claim 19, wherein the heat-dissipating filler is contained in an amount of 20 to 60 parts by volume with respect to 100 parts by volume of a mixture of the vitrimer powder and the heat-dissipating filler.
